(19) United States
(12) Patent Application Publication
(10) Pub. No.: US 2010/0037148 A1
(43) Pub. Date: Feb. 11, 2010

(54) Social Networking Tool

(75) Inventors: Richard Harper, Cambridge (GB); Philip Gosset, Stroud (GB); Richard Banks, Egham (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/187,081

(22) Filed: Aug. 6, 2008

(51) Int. Cl. G06F 3/01

(52) U.S. Cl. 715/752

(57) ABSTRACT

A social networking tool is described for use with a display. In an embodiment, the display is permanently located in an enterprise office and facilitates social interaction between users some of whom are remote of the display and at least one of whom is physically local to the display. In an embodiment messages comprising content are received from remote users and the content displayed. One display region for each remote user is displayed concurrently and content received from any particular remote user is only displayed in the display region for that remote user. In an embodiment a user local to the display is able to send a message to a remote user by selecting the appropriate display region. In another embodiment a user local to the display is able to change the position of the display regions on the display and may also annotate the display.

### BACKGROUND

Existing social networking tools such as web services enable users to post content such as images and text on a homepage with the expectation that friends will visit that site as and when they see fit. In this way the social networking tool supports the identity and presence of users and facilitates social interaction between users. Typically users upload content to their homepages using a web based interface provided by the web service.

Visitors to the site are typically required to travel from one such homepage to another in serial fashion. It requires effort to do this traveling between homepages, albeit that this traveling is little more than click-throughs.

The embodiments described below are not limited to implementations which solve any or all of the disadvantages of known social networking tools.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A social networking tool is described for use with a display. In an embodiment, the display is permanently located in a break out area in an enterprise office and facilitates social interaction between users some of whom are remote of the display and at least one of whom is physically local to the display. In an embodiment a processor controls the display and provides a user interface associated with the display. Messages comprising content are received from the remote users and the content displayed at the display. One display region for each remote user is displayed concurrently on the display and content received from any particular remote user is only displayed in the display region for that remote user. In an embodiment a user local to the display is able to send a message to a remote user by selecting the appropriate display region. In another embodiment a user local to the display is able to change the position of the display regions on the display and may also annotate the display.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a social networking tool in conjunction with a communications network;

FIG. 2 is a block diagram of a method at a remote user device;

FIG. 3 is a block diagram of a method at a control device;

FIG. 4 is a schematic diagram of a display at a situated display;

FIG. 5 is a schematic diagram of another display at a situated display;

FIG. 6 is a schematic diagram of another display at a situated display;

FIG. 7 is a schematic diagram of another display at a situated display;

FIG. 8 illustrates an exemplary computing-based device in which embodiments of a social networking tool may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an enterprise social networking system, the system described is provided as an example and not a limitation. As those skilled in the art will appreciate, the present examples are suitable for application in a variety of different types of social networking systems including domestic or family systems.

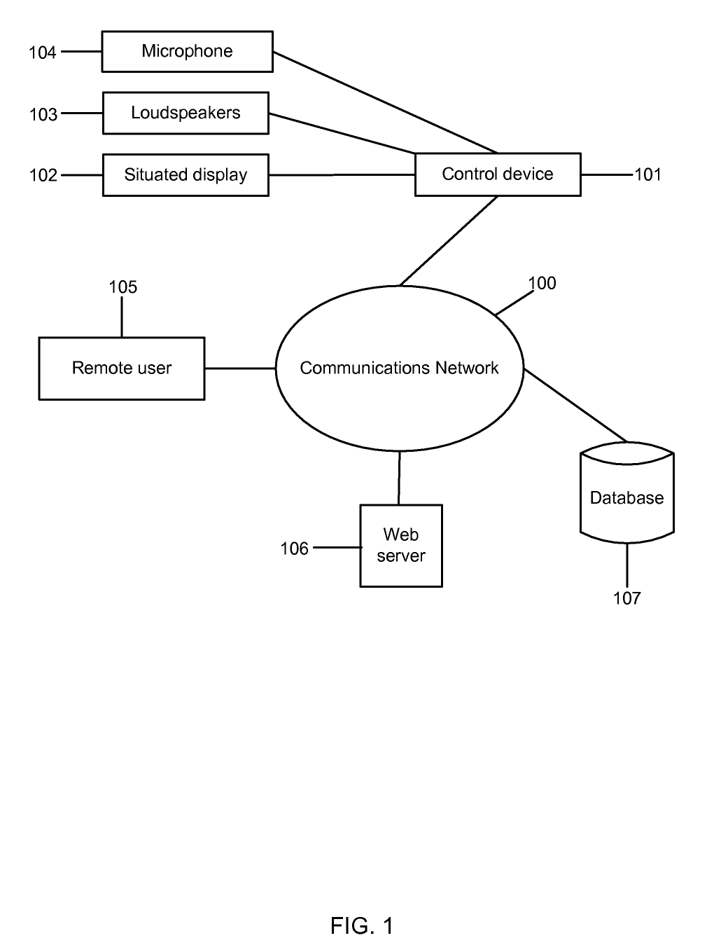

FIG. 1 is a schematic diagram of a social networking tool comprising a control device 101 arranged to control a situated display 102 and optionally also a loudspeaker 103 and microphone 104 associated with the situated display 102. In a preferred example the control device is integrated with or local to the situated display. The control device has the ability to receive content items for display and to render those content items to the situated display as described in more detail below. The control device may be a personal computer or other computing device. In some embodiments the control device 101 has the minimum resources and processing capacity required to meet its functional requirements in order that its cost, size, maintenance and upgrade requirements are kept low. This is particularly advantageous for situated displays in remote locations such as in domestic kitchens or other locations where technical support is not readily available.

The situated display 102 is an automated display which is physically fixed to and permanently associated with a particular physical location, be that location a geographical location, or a site on another object. Situated displays, being automated displays embedded in an environment exist in many forms today. For example, electronic displays for advertisements fixed to the outsides of buildings in prominent places, electronic ticker displays such as those fixed to bus stops and other public transport infrastructure such as rail stations, underground trains and the like, and digital image displays used at nightclubs and in auditoria and concert venues. In contrast, non-situated displays such as screens associated with personal computers, laptops, mobile phones and the like are not “situated” because these are not considered as being embedded in a particular environment. That is, a given personal computer screen is not associated with or fixed to a particular physical location; it can be moved. Also, a personal computer screen can be shared by different users operating the PC at different times. The screen itself is then not permanently associated with, say, “John's office” because sometimes Jane may use it as well. However, an electronic ticker display at a bus stop is fixed to that particular bus stop and is permanently associated with that bus stop. A situated display can be fixed to a movable item, such as a car or underground train however. In that case it is permanently associated with the car or underground train concerned. Thus the term “situated display” is used herein to refer to a display which is physically fixed to and permanently associated with a particular physical location, be that location a geographical location, or a site on another object. In addition, non-situated displays such as PC screens and mobile phone screens are primarily user interface displays; that is, they are intended to provide a display of information about what the PC or the mobile is doing. They can be considered as a mechanism for and/or a channel through which interaction with the PC or mobile can be done. In contrast, a situated display is designed primarily for the display of content generated by entities elsewhere. The information displayed is the key value provided and not the ability to interact with the Personal or Mobile Computer.

Associated with the situated display 102 is at least one address and in some embodiments a plurality of addresses for different types of communications media. For example, an email address and a telephone number.

In one embodiment the social networking tool is for use in an enterprise. For example, the situated display 102 is a display screen permanently located in an office break-out area or other communal area at an enterprise site. The display screen may be a digital display screen or any other type of electronic display. The situated display could also comprise a projector or other means projecting onto any suitable surface such as a wall, ceiling or floor.

The situated display has an associated user interface, either integral with the situated display or associated with the display and also connected to the control device 101. For example, the situated display may comprise a digital touch screen in which case the user interface is provided as part of the situated display. The situated display may be an interactive display. In another example, the user interface may comprise a keyboard and mouse connected to the control device 101. Any suitable type of user interface may be used in conjunction with the situated display. The user interface is arranged such that it is only operable by users local to the situated display and not by remote users.

The control device 101 is connected to a communications network 100 of any suitable type and a remote user 105 has access to the social networking tool via that communications network 105. Only one remote user is shown in FIG. 1 although many such remote users may be present. The remote user may be a communications device operable by an individual or the remote user may be an automated service.

In an example, a social networking service is provided in the form of a web service using a web server 106. Web pages are presented which enable a remote user 105 to register with a social networking service and interact with that service as described in more detail below. A database 107 for storing details of remote users may be provided as an independent entity or integral with the control device 101 or web server 106.

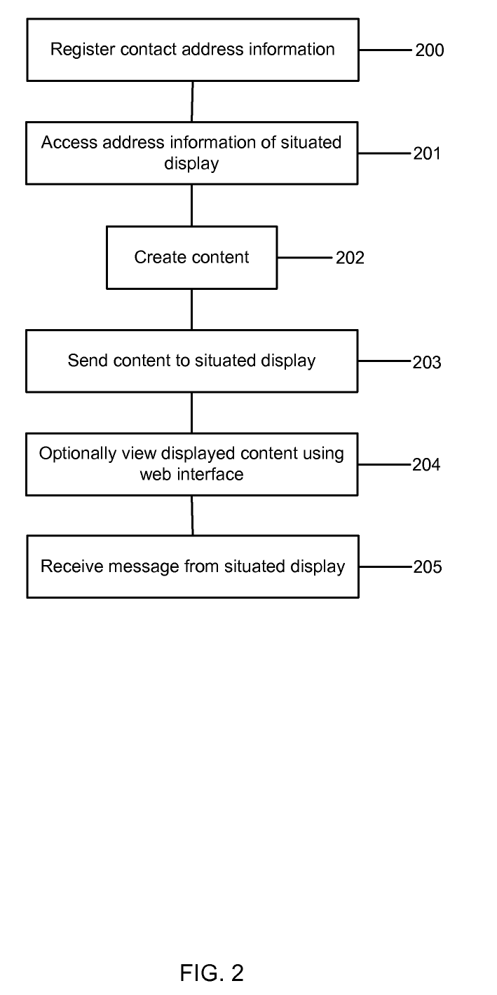

A remote user who is invited to use the social networking tool needs to register his or her contact address information (block 200 of FIG. 2). For example, this is achieved by inviting the remote user to visit a web page provided by the web server 106 and to enter his or her contact address information which is then stored in an index or other structure at database 107. The remote user is also able to access (block 201) address information of the situated display 102 from the web page or from any other suitable source. For example, the remote user obtains a telephone number and an email address of the situated display.

The remote user creates content which he or she desires to post on the situated display (block 202). This content is created in any suitable manner, for example, using a camera to take a photograph, using a word processing application to input text, using a telephone to create a voice message or using a mobile telephone to create an SMS message. The remote user sends a message comprising the content to the situated display (block 203). For example, the remote user makes a telephone call to the situated display and leaves a voice message. Alternatively, the remote user sends an SMS or email message to the situated display. The message is received by the control device 101 and the content rendered on the situated display 102 as described in more detail below with reference to FIG. 2. The display at the situated display may itself be a web page such that the remote user is then able to view the displayed content using a web browser (block 204).

Previously, social networking tools have required users to upload content to their homepages using a web based interface provided by a web service. In the embodiment described above, a user is able to upload content in a simple and effective manner by sending an email message, SMS message or the like to a situated display. The content may be viewed by users local to the situated display screen and may also be viewed by remote users, for example, using a web browser.

Messages may also be sent from the situated display 102 to one or more remote users 105. Thus a remote user in the method of FIG. 2 is able to receive a message from the situated display (block 205). This message may be of any suitable type, such as an email, telephone message, SMS message or other type of message. The contact address information provided by the remote user at registration is used by the control device 101 to determine where to send the message to.

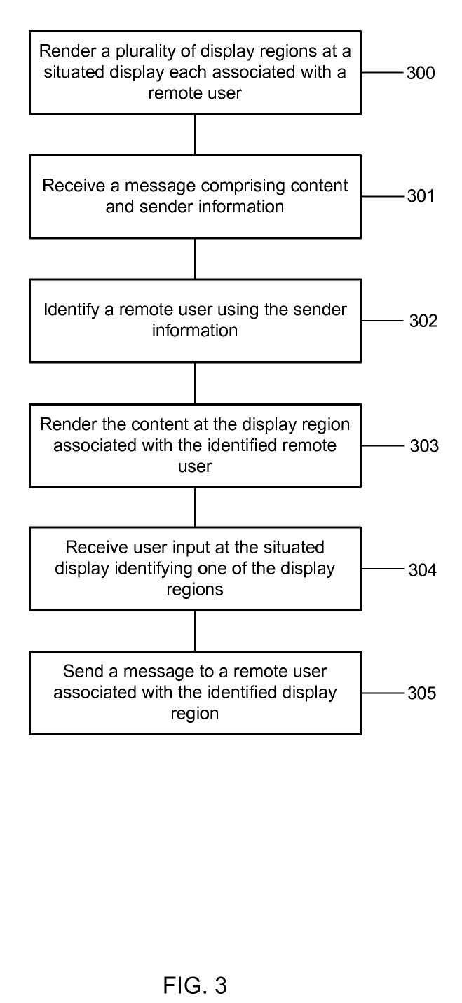

In an embodiment the control device 101 is arranged to automatically render a plurality of display regions at the situated display 102, each region being associated with a remote user (block 300 of FIG. 3). The plurality of display regions are concurrently visible. The control device 101 has one or more inputs arranged to receive messages from remote users. The messages may be of any suitable type and comprise content and sender information (block 301). Once a message is received the control device 101 identifies which remote user sent the message by using the sender information in the message (block 302) and renders the content from the message at the display region associated with the identified remote user (block 303). This is repeated for other messages received from the same or different remote users. As a result, the situated display shows content information concurrently from different remote users on a single display. For example, the content information may be social networking information or any other suitable type of information.

The control device 101 is also arranged to receive input (block 304) as a result of user input associated with the situated display 102. The user input acts to identify one of the display regions and thus a remote user associated with that display region. A user local to the situated display is thus able to interact with the situated display to select a remote user. The local user is also able to generate content for example, using a user interface associated with the situated display and/or using the microphone 104. That content is received by the control device 101 and may be sent to a remote user identified by the local user as described above. The content may be sent as part of a message (block 305) of any suitable type such as email, SMS, voice mail or the like.

In some embodiments the situated display comprises a touch-screen whereby users are able to select regions of the display by touching those regions and to drag and drop displayed items or draw on the screen by making appropriate hand or finger movements across or just above the screen.

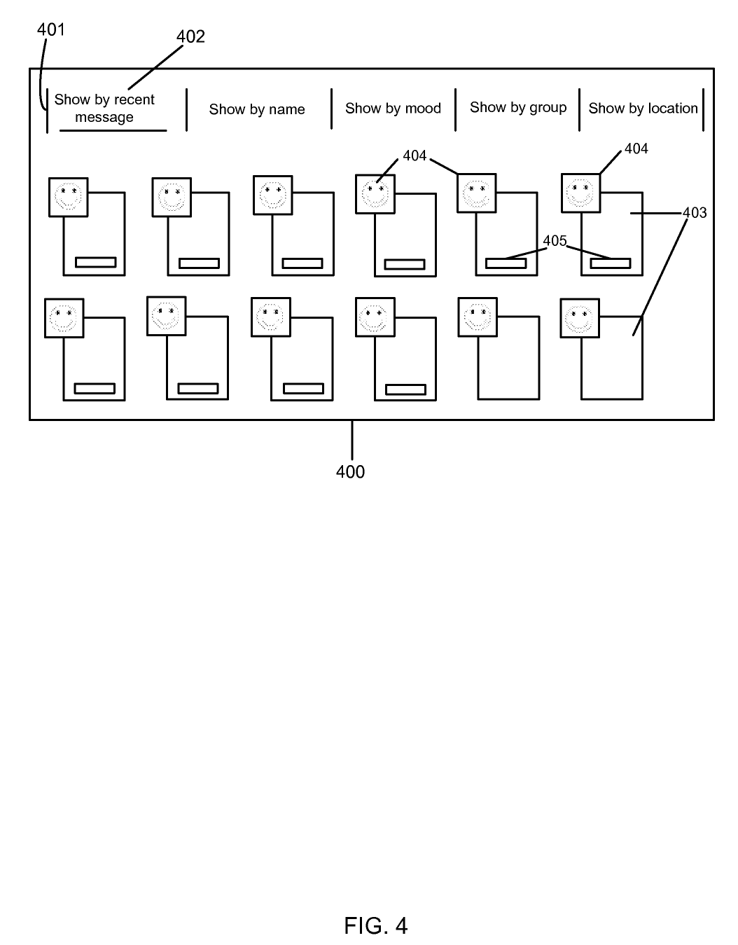

An embodiment in which the social networking tool is used in an enterprise having a department comprising a team of 12 staff is now described. Contact addresses comprising an email address and a telephone number for each member of staff is stored at database 107. The web server 106 is arranged to dynamically generate a plurality of web pages which are served to the situated display 102 via control device 101. Examples of those web pages are shown in FIGS. 4 to 7.

A first one of the web pages forms a display 400 comprising 12 display regions 403 one for each member of staff. Each display region has a sub region 404 in which a picture of the member of staff is displayed. Those pictures may be stored at the database 107 or any other suitable location. In the event that a member of staff has sent a message comprising text-based content to the social networking tool that text is displayed at an area 405 within the display region 403 for that staff member. The text-based content may be formed from a voice message sent by the staff member and using an automated voice to text converter connected to the communications network 100. In the event that a member of staff has sent a message comprising image based content to the social networking tool that image is displayed at the display region 403 for the staff member. Any audio based content may be played back using loudspeakers 103 when a user local to the situated display 102 makes an appropriate user input.

For any staff member who has not yet sent any message to the social networking tool, the corresponding display region is blank apart from the sub region showing an image of the staff member 404.

In the example shown in FIG. 4 a menu strip 401 is presented giving options for different arrangements of the displayed content. If “show by recent message” is selected as in FIG. 4 the display regions are arranged on the web page in order of recency of messages received from the staff members. If “show by name” is selected the display regions are arranged on the web page in alphabetical order of the staff member names. If “show by mood” is selected the display regions are arranged on the web page in groups selected by users local to the situated display. For example, a local user may drag and drop the display regions so that all the staff members he or she considers to be in a celebratory mood are grouped together. The display regions remain in those positions whenever the “show by mood” option is selected unless they are dragged and dropped to new locations by a remote user. The identity of the local user who groups the display regions is hidden from the remote users unless the local user chooses to make his or her identity known, for example, by sending messages to the remote users. In this way the social networking tool facilitates interaction between local and remote users in a manner not previously possible using existing social networking tools. The social networking tool thus facilitates the establishment of group identities within a population of users operating the tool.

The same process as for “show by mood” occurs when “show by group” is selected although the local user may form the groups on the basis of other types of judgement besides his or her perceived mood of the individual staff members. A similar process occurs when “show by location” is selected. Here a local user may form groups on the basis of geographical locations of the staff members, such as those in the office and those away on business. Any other similar options for arrangements of the displayed regions may be provided.

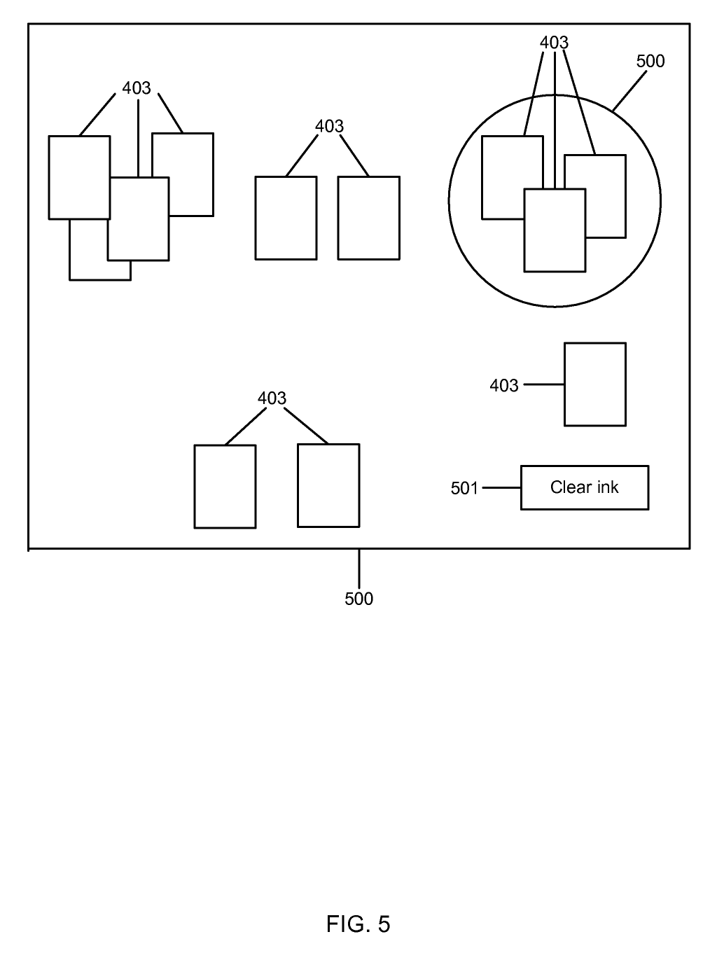

FIG. 5 is an example of a web page display in which the “show by group” option has been selected. The display regions 403 for the 12 staff members are arranged in groups on the display. One of the groups has three display regions and an electronic-ink line 500 is drawn around this group as a result of a user action such as a finger movement on the situated display. In order to clear the electronic ink of the line 500 a button 501 may be selected.

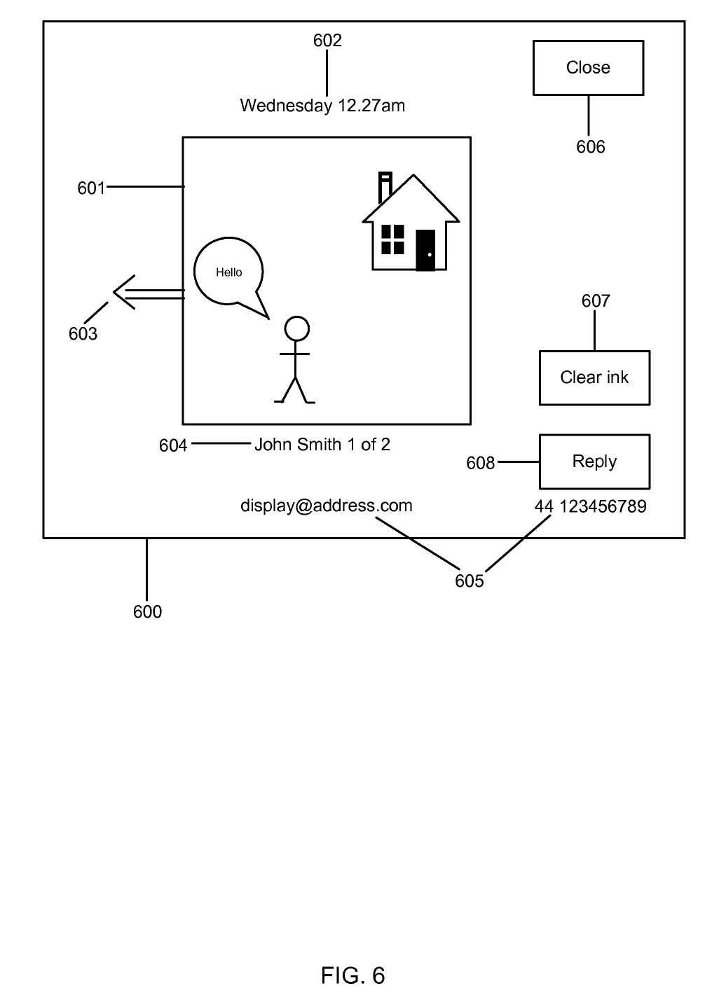

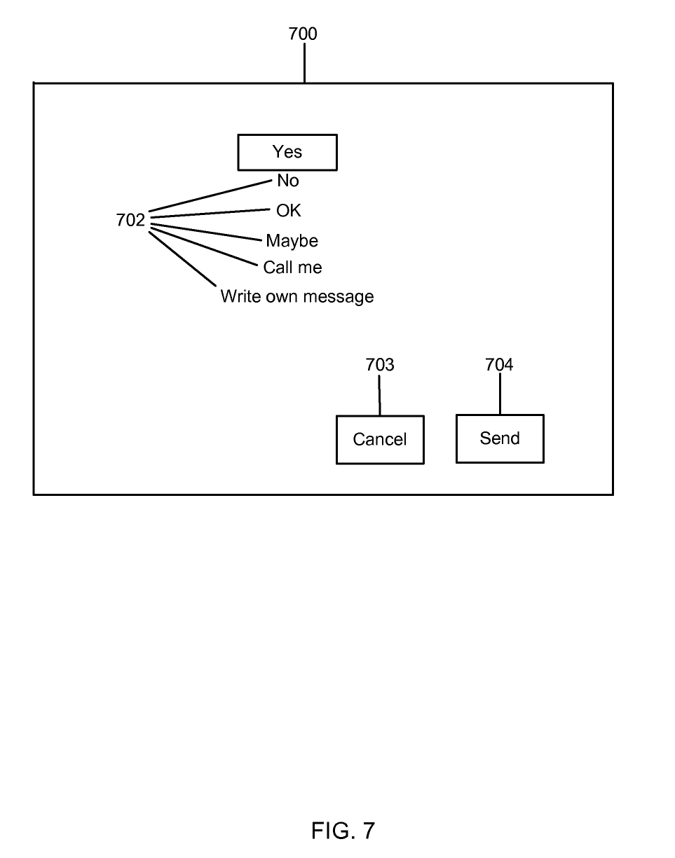

FIG. 6 is an example of a web page display in which a display region 403 for one of the 12 staff members has been selected. An enlarged view 601 of the display region 403 for that staff member is presented. Text 604 is shown indicating the name of the staff member and the number of windows of content available for that staff member. In this example, two windows of content are available. Arrow 603 is presented on the web page, which when selected, enables the other window of content to be shown. Other text information may be presented 602 such as the day and time at which the content was received. Information 605 about any addresses of the situated display may also be presented although this is not essential. A button 606 for closing the display and returning to a display in which all twelve regions are shown is provided. Also, “clear ink” button 607 and “reply” button 608 may also be displayed. When the “clear ink” button is selected any electronic ink drawn on the display is removed. When the “reply” button is selected one or more web pages are presented for enabling a user local to the situated display to create a message for sending to a remote user. For example, this is now described with reference to FIG. 7.

FIG. 7 is an example of a web page display presented after the “reply” button 608 of FIG. 6 has been selected. A plurality of words 701, 702 and phrases are listed that a user local to the situated display is able to choose from for sending to the remote user associated with the display 601 of FIG. 6. For example, if the word “yes” 701 is selected as shown in FIG. 7 an email may be automatically generated, containing the word “yes”, and sent using a send button 704 to an email address of a remote user selected during presentation of earlier web page displays. Any other suitable type of message may be generated and sent, such as an SMS message, voice message or other message. It is not necessary to make the contact addresses of the remote user known to the local user as the process of creating and sending the message to the remote user is transparent and automatic. In order to indicate to the local user that a message has been sent a flashing icon or other indicator may be presented at the situated display. When the remote user receives the message, the remote user may be able to ascertain that the message has been sent from the situated display but the identity of the local user may be hidden. The user local to the situated display also has the option to write his or her own message in which case one or more further web pages are presented to enable to local user to do that. A cancel option 703 may also be provided. Other similar web page displays may be provided to enable a local user to generate other types of content such as images, video, sound, or graphics and to send that to remote users using any suitable message type.

Message generating software for automatically forming an email message, SMS message or other type of message is provided at the control device 101 or at any other suitable location in the communications network 100 that is accessible to the control device 101.

The social networking tool is arranged to differentiate between those users local to the situated display and those users remote from the situated display. For example, the user interface is arranged such that it is only operable by users local to the situated display thus giving those users a reward or incentive to use the tool as compared with remote users. Also, users local to the situated display are able to annotate content, send messages and group display regions whilst keeping their identity hidden from remote users.

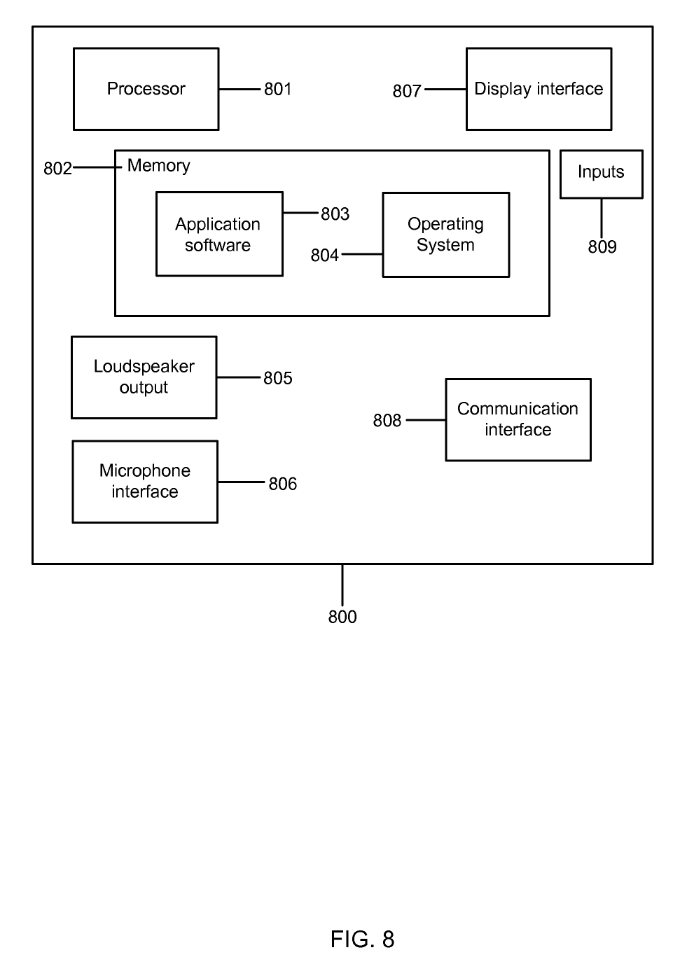

FIG. 8 illustrates various components of an exemplary computing-based device 800 which may be implemented as any form of a computing and/or electronic device, and in which embodiments of a control device for a situated display social networking tool may be implemented.

The computing-based device 800 comprises one or more inputs 809 which are of any suitable type for receiving media content, Internet Protocol (IP) input, images, video, text or other content. The device also comprises communication interface 808 arranged to enable to device to send and receive messages over a communications network, those messages being of any suitable type such as email, SMS, voice mail, or other messages.

Computing-based device 800 also comprises one or more processors 801 which may be microprocessors, controllers or any other suitable type of processors for processing computing executable instructions to control the operation of the device in order to control a situated display in such a manner as to provide a social networking tool. Platform software comprising an operating system 804 or any other suitable platform software may be provided at the computing-based device to enable application software 803 to be executed on the device. The application software may comprise software for generating messages such as email messages, SMS messages or other messages.

The computer executable instructions may be provided using any computer-readable media, such as memory 802. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An interface 807 to a situated display is provided for rendering content to the situated display and for providing a user interface associated with the situated display. A loudspeaker output 805 may be provided although this is not essential. Also a microphone interface 806 may be provided which is also not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A social networking tool for use by a plurality of users physically remote from a display and at least one user physically local to the display comprising:
a processor arranged to control the display and to provide a user interface associated with the display,
an input arranged to access address information of the plurality of remote users;
an input arranged to receive messages comprising content from the remote users;
the processor being arranged to display the content using a plurality of display regions concurrently present on the display, each display region being associated with only one of the remote users and whereby content received from any particular remote user is only displayed in a display region associated with that remote user;
the processor being arranged to generate a message on the basis of input by the local user at the user interface that input being associated with one of the display regions, the message comprising content and to send that message to the remote user associated with the display region.

2. A social networking tool as claimed in claim 1 wherein the processor is arranged to control a situated display which is permanently associated with a particular physical location.

3. A social networking tool as claimed in claim 1 wherein the input arranged to receive messages has an associated address selected from any of an email address and a telephone number.

4. A social networking tool as claimed in claim 1 wherein the message is only sent if the display region associated with the remote user already comprises content received from that remote user.

5. A social networking tool as claimed in claim 1 wherein the processor is arranged to generate the message such that any information about the local user is absent from that message.

6. A social networking tool as claimed in claim 1 wherein the processor is arranged to generate the message such that it is any of an email, an SMS message, and a telephone message.

7. A social networking tool as claimed in claim 1 wherein the processor is arranged to control the display and user interface such that positions of the display regions on the display may be changed in order to group the display regions as a result of local user input at the user interface.

8. A social networking tool as claimed in claim 1 wherein the processor is arranged to control the display and user interface such that positions of the display regions on the display may be changed in order to group the display regions only as a result of local user input at the user interface.

9. A social networking tool as claimed in claim 1 wherein the processor is arranged to control the display and user interface such that annotations may be made to the display only as a result of local user input at the user interface.

10. A method of providing a social networking tool for use by a plurality of users physically remote from a display and at least one user physically local to the display comprising:
using a processor to control the display and to provide a user interface associated with the display,
accessing address information of the plurality of remote users;
receiving messages comprising content from the remote users;
arranging the processor to display the content using a plurality of display regions concurrently present on the display, each display region being associated with only one of the remote users and whereby content received from any particular remote user is only displayed in a display region associated with that remote user;
generating a message on the basis of input by the local user at the user interface that input being associated with one of the display regions, the message comprising content; and
sending that message to the remote user associated with the display region.

11. A method as claimed in claim 10 which comprises providing an email address associated with the display at which at least some of the messages are received from the remote users.

12. A method as claimed in claim 10 which further comprises only sending a message to the remote user if the display region associated with the remote user already comprises content received from that remote user.

13. A method as claimed in claim 10 which comprises generating the message such that any information about the local user is absent from that message.

14. A method as claimed in claim 10 which comprises generating the message such that it is any of an email, an SMS message, and a telephone message.

15. A method as claimed in claim 10 which comprises controlling the display and user interface such that positions of the display regions on the display may be changed in order to group the display regions as a result of local user input at the user interface.

16. A method as claimed in claim 10 which comprises controlling the display and user interface such that positions of the display regions on the display may be changed in order to group the display regions only as a result of local user input at the user interface.

17. A method as claimed in claim 10 which comprises controlling the display and user interface such that annotations may be made to the display only as a result of local user input at the user interface.

18. A method of providing a social networking tool for use by a plurality of users physically remote from a display, being a situated display permanently associated with a physical location, and at least one user physically local to the display comprising:
using a processor to control the display and to provide a user interface associated with the display,
accessing address information of the plurality of remote users;
receiving messages comprising social networking content from the remote users;
arranging the processor to display the content using a plurality of display regions concurrently present on the display, each display region being associated with only one of the remote users and whereby social networking content received from any particular remote user is only displayed in a display region associated with that remote user;
generating a message on the basis of input by the local user at the user interface that input being associated with one of the display regions, the message comprising social networking content;
sending that message to the remote user associated with the display region; and
controlling the display and user interface such that positions of the display regions on the display may be changed in order to group the display regions as a result of local user input at the user interface.

19. A method as claimed in claim 18 which comprises controlling the display and user interface such that positions of the display regions on the display may only be changed in order to group to display regions as a result of local user input at the user interface.

20. A method as claimed in claim 18 which comprises controlling the display and user interface such that annotations may be made to the display only as a result of local user input at the user interface
